(19) United States
(12) Patent Application Publication
(10) Pub. No.: US 2017/0255078 A1
(43) Pub. Date: Sep. 7, 2017

(54) WAVELENGTH SELECTIVE SWITCH WITH MONITORING PORTS

(71) Applicant: ZHIPING JIANG, KANATA (CA)

(72) Inventor: ZHIPING JIANG, KANATA (CA)

(73) Assignee: HUAWEI TECHNOLOGIES CO., LTD., Shenzhen (CN)

(21) Appl. No.: 15/060,037

(22) Filed: Mar. 3, 2016

(51) Int. Cl. G02F 1/313; G02B 6/35

(52) U.S. Cl. CPC G02F 1/313; G02B 6/351; G02B 6/3548

(57) ABSTRACT

Apparatuses and methods for wavelength selective switching and optical performance monitoring are provided. Spatially separated wavelength channels of an optical signal are directed onto an optical deflector array. The optical deflector array is configured so that each wavelength channel is incident on a respective region of the optical deflector array. The optical deflector array is controlled so that, for one or more of the wavelength channels: i) a first portion of the region of the optical deflector array upon which the wavelength channel is incident is configured to steer a first portion of the wavelength channel toward a switching output port; and ii) a second portion of the region is configured to steer a second portion of the wavelength channel toward a monitoring output port.

### FIELD OF THE APPLICATION

The application relates generally to optical communication network devices, and in particular embodiments to wavelength selective switches with monitoring ports and methods thereof.

### BACKGROUND

Optical networks are employed to support the demand for high-speed, high-capacity advanced telecommunications and data networks. These optical networks commonly utilize optical dense wavelength division multiplexing (DWDM) to exploit the available optical spectrum. In optical DWDM, data is modulated onto several different carrier waves of different wavelengths, commonly referred to as channels or channel wavelengths.

Many optical networks employ optical nodes that correspond to branch points of the optical network. Often, these nodes employ Reconfigurable Optical Add Drop Multiplexer (ROADM) devices that allow for the removal or addition of one or more channel wavelengths at a node.

In order to realize a ROADM device, a wavelength selective switch (WSS) may be employed for the routing of the channel wavelengths. In many WSS architectures, an optical deflection device, such as a liquid crystal on silicon (LCoS) phased array switching engine, may be used to select a channel wavelength for routing to a desired output port of the WSS. For example, routing of a channel wavelength of a DWDM signal to a drop port results in that channel wavelength being dropped from the incoming DWDM signal.

ROADM nodes often employ some form of optical performance monitor (OPM) to allow for monitoring of the optical signals present at the ports of the ROADM node and/or at monitoring locations within the ROADM node. The OPM may monitor properties such as channel power and/or optical signal to noise ratio, for example. Many OPM devices utilize a scanning narrow bandwidth optical tunable filter or spectrometer. The OPM devices are typically separate from the other devices of the ROADM node, such as the WSSs, and are connected to the various monitoring locations/ports of the ROADM node via optical taps.

### SUMMARY

One broad aspect of the present disclosure provides a method for wavelength selective switching and optical performance monitoring. The method includes receiving at least one spatially separated wavelength channel of an optical signal on an optical deflector array. The optical deflector array is configured so that each wavelength channel is incident on a respective region of the optical deflector array. The method further includes controlling the optical deflector array so that, for one or more of the at least one wavelength channel: i) a first portion of the region of the optical deflector array upon which the wavelength channel is incident is configured to steer a first portion of the wavelength channel toward a first output port; and ii) a second portion of the region is configured to steer a second portion of the wavelength channel toward a second output port. In some embodiments, the first output port is a switching output port and the second output port is a monitoring output port.

Another broad aspect of the present disclosure provides an apparatus that includes one or more first output ports, one or more second output ports, an optical deflector array, such as a LCoS pixel array, and a controller. The optical deflector array is configured to receive at least one spatially separated wavelength channel of an optical signal, with each wavelength channel being incident on a respective region of the optical deflector array. The controller is operatively coupled to the optical deflector array and is configured to control the optical deflector array so that, for one or more of the wavelength channels: i) a first portion of the region of the optical deflector array upon which the wavelength channel is incident is configured to steer a first portion of the wavelength channel toward one of the one or more first output ports; and ii) a second portion of the region is configured to steer a second portion of the wavelength channel toward one of the one or more second output ports.

A further broad aspect of the present disclosure provides a wavelength selective switch (WSS) that includes an apparatus according to the above aspect of the present disclosure.

### BRIEF DESCRIPTION OF THE DRAWINGS

Embodiments will now be described with reference to the attached drawings in which:

FIG. 1 is a block diagram of an optical network in which embodiments of the present disclosure may be implemented;

FIG. 2 is a block diagram of a three-degree ROADM node architecture in which embodiments of the present disclosure may be implemented;

FIG. 3 is a block diagram of a 1×5 WSS;

FIG. 4 is a diagram of an example of an optical deflector array based 1×5 WSS that may be utilized to implement the 1×5 WSS of FIG. 3;

FIG. 5 is a diagram of a portion of an optical deflector array based 1×5 WSS;

FIG. 6 is a perspective view of a portion of an optical deflector array;

FIG. 7A is a perspective view of a portion of an optical deflector array according to an embodiment of the present disclosure;

FIG. 7B is a plot showing the profiles of the two different phase progressions of the array shown in FIG. 7A;

FIG. 8 is a diagram of a portion of an optical deflector array based 1×5 WSS according to an embodiment of the present disclosure;

FIG. 9 is a block diagram of a 1×5 WSS with a single optical monitoring output port according to an embodiment of the present disclosure;

FIG. 10 is a block diagram of a 1×5 WSS with two optical monitoring output ports according to an embodiment of the present disclosure; and

FIG. 11 is a flow diagram of example operations in an apparatus according to example embodiments described herein.

### DETAILED DESCRIPTION OF EMBODIMENTS

Wavelength selective switches (WSSs) and optical performance monitoring (OPM) are used in DWDM systems. Embodiments of the present disclosure incorporate a monitoring port in a WSS.

A DWDM optical network supports a plurality of wavelength-multiplexed optical channels with central wavelengths λᵢ, i=1, . . . , N. These optical channels are typically spaced uniformly in frequency and lie on a predefined grid, for example corresponding to 50 GHz, 100 GHz or 200 GHz frequency spacing. In this context, wavelength channels will be referred to according to the channel central wavelengths λᵢ. It is also noted that the number N of wavelength channels in the network may be implementation specific, with typical examples being in the range of 40 to 96. However, it will be appreciated that a uniform frequency spacing of wavelengths channels is not a requirement for the present disclosure. For example, embodiments are contemplated that support flex-grid compatibility, where channel bandwidths and/or spacings may be non-uniform and/or adaptable.

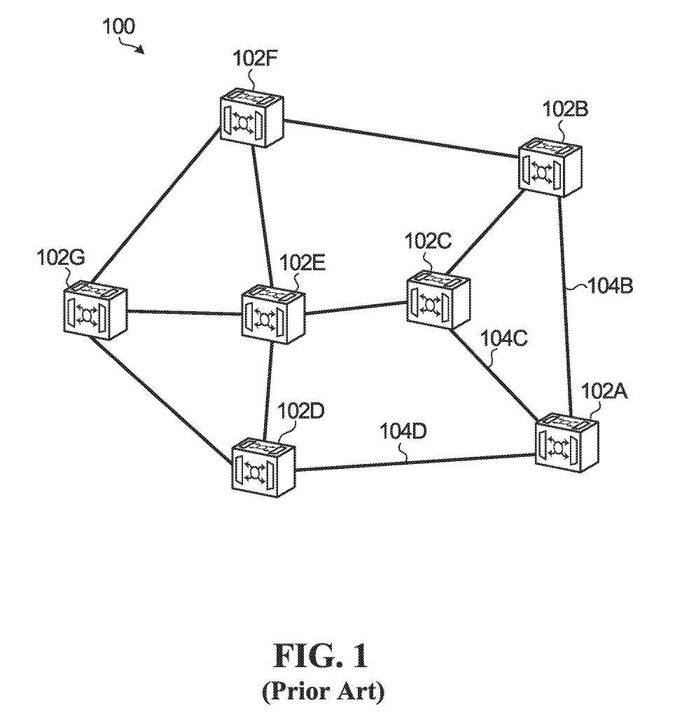

FIG. 1 is a block diagram of an example optical network 100 in which embodiments of the present disclosure could be implemented. The optical network 100 includes seven access ROADM nodes 102A, 102B, 102C, 102D, 102E, 102F and 102G that are interconnected via optical communication links as shown in FIG. 1. For example, Access ROADM node 102A is interconnected with access ROADM nodes 102B, 102C and 102D via optical communication links 104B, 104C and 104D, respectively. Because access ROADM node 102A is interconnected with three other access ROADM nodes (access ROADM nodes 102B, 102C and 102D), it may be referred to as a three-degree access ROADM node.

The optical communication links between the access ROADM nodes 102A, 102B, 102C, 102D, 102E, 102F and 102G may be optical fiber communication links, for example.

A person of ordinary skill will understand that an optical network may also include amplification nodes between access ROADM nodes, but such amplification nodes are not shown in FIG. 1 for the sake of simplicity.

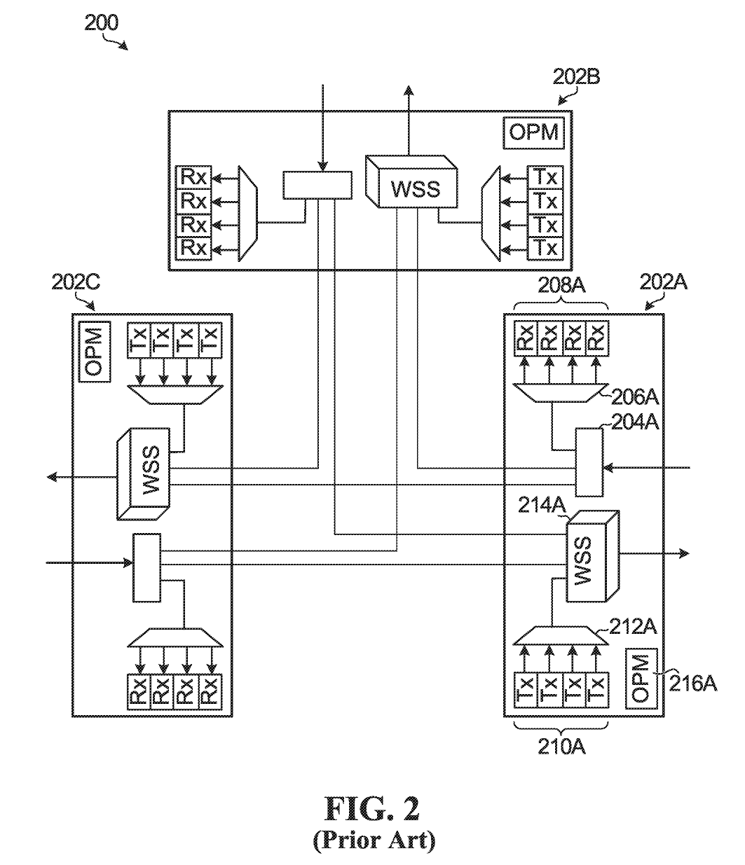

FIG. 2 is a block diagram of a three-degree ROADM node architecture 200 for a DWDM optical network that utilizes three WSS based ROADM elements 202A, 202B and 202C, which enable selectively adding and dropping wavelengths onto and from the network and supporting traffic in three directions to communicate with three neighboring network nodes. The node architecture 200 may be used to implement the three-degree access ROADM node 102A shown in FIG. 1 for example.

The ROADM element 202A includes an input optical splitter 204A, a drop demultiplexer 206A, a plurality of local receivers 208A, a plurality of local transmitters 210A, an add multiplexer 212A, a WSS 214A and an OPM device 216A. The ROADM elements 202B and 202C are the same as ROADM element 202A. These components are optically interconnected as shown in FIG. 2 so that traffic coming from any of the three directions can be directed to any of the other directions via an optical communication path from the optical splitter of the inbound direction to the WSS of the outbound direction, or traffic can be directed to the local receivers for the inbound direction via an optical communication path from the optical splitter of the inbound direction to the demultiplexer of the inbound direction. Traffic from the local transmitters for an outbound direction can be directed to any of the three direct ions via an optical communication path from the multiplexer of the outbound direction to the WSS of the outbound direction.

The OPM devices are used for optical performance monitoring at various monitoring points within the node, such as at the input ports and/or the output port of the respective WSS, for example.

As will be appreciated, operating a ROADM node architecture 200 such as that illustrated in FIG. 2 generally involves configuring and controlling its constituent WSS devices, which includes controlling the configuration and adaptation of wavelength paths through the WSS device. Part of the control of the WSS devices may be based, at least in part, on OPM information generated by the OPMs.

It is noted that the ROADM node architecture 200 shown in FIG. 2 is merely one example of a WSS based ROADM node architecture that may be used to realize a ROADM node. Other architectures and/or variations are possible and are contemplated within the context of the present disclosure. For example, in some cases the optical splitters that are included as part of the WSS based ROADM elements may be replaced with WSSs so that wavelength channels may be selectively routed to the local receivers or to the WSSs in the other WSS based ROADM elements. In some cases, optical amplifiers may be used at the input and/or output ports of the WSS ROADM elements to amplify optical signals received at an input port or transmitted to an output port. Such amplifiers may be needed to offset at least some of the losses that may be incurred as an optical signal propagates through the network, such as losses through the splitting performed by the optical splitters, for example.

It is noted that the WSSs shown in FIG. 2 are all 3×1 WSSs, in that they are configured to selectively switch wavelength channels from their three optical switching output ports to their single optical switching output port. Other known wavelength selective switch configurations include one optical switching input port and multiple optical switching output ports, where the WSS is configured to selectively switch wavelength channels from the single optical switching input port to one of its multiple optical switching output ports.

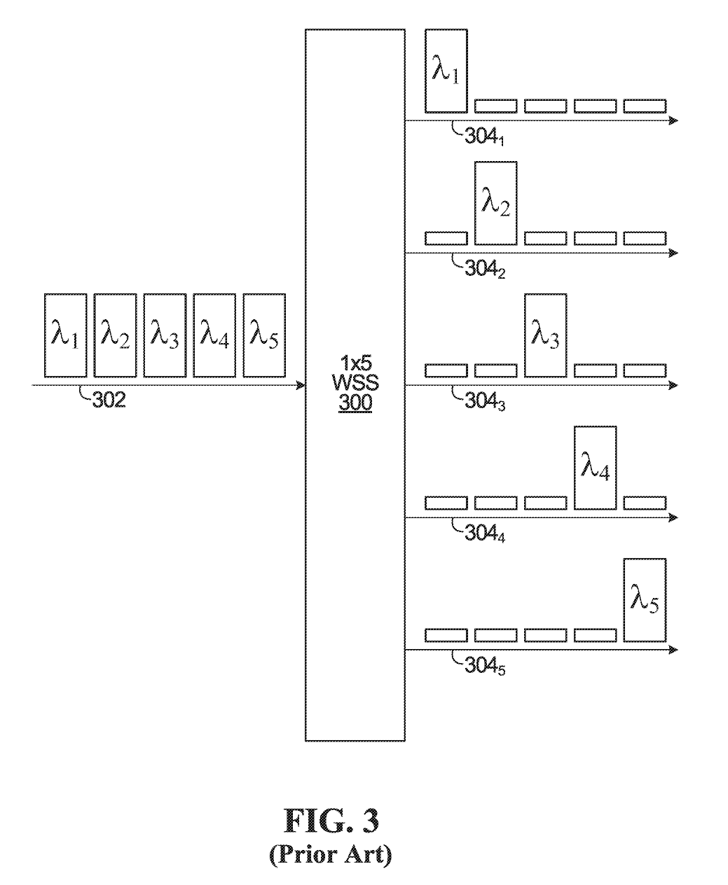

FIG. 3 is a block diagram of an example configuration of a 1×5 WSS 300. The 1×5 WSS 300 has a single input port 302 for receiving an optical input signal comprising wavelengths channels λ₁, λ₂, λ₃, λ₄, λ₅ and five switching output ports 304₁, 304₂, 304₃, 304₄ and 304₅. Through control signals (not shown in FIG. 3) to the WSS 300, each wavelength channel from the input signal can be dynamically switched or routed to any one of the output ports 304₁, 304₂, 304₃, 304₄ and 304₅. Depending on how the WSS 300 is implemented, each wavelength channel may he dynamically routed independently of the other wavelength channels.

For illustrative purposes, in FIG. 3 the WSS 300 is shown as being configured such that each of the wavelength channels λ₁, λ₂, λ₃, λ₄, and λ₅ of the input signal is routed to a respective one of the output ports 304₁, 30₂, 304₃, 304₄ and 304₅.

However, it should be noted that in other configurations two or more channel wavelengths may be routed to the same output port and/or one or more of the channel wavelengths may be blocked or attenuated by the WSS so that they are not routed to any of the output ports.

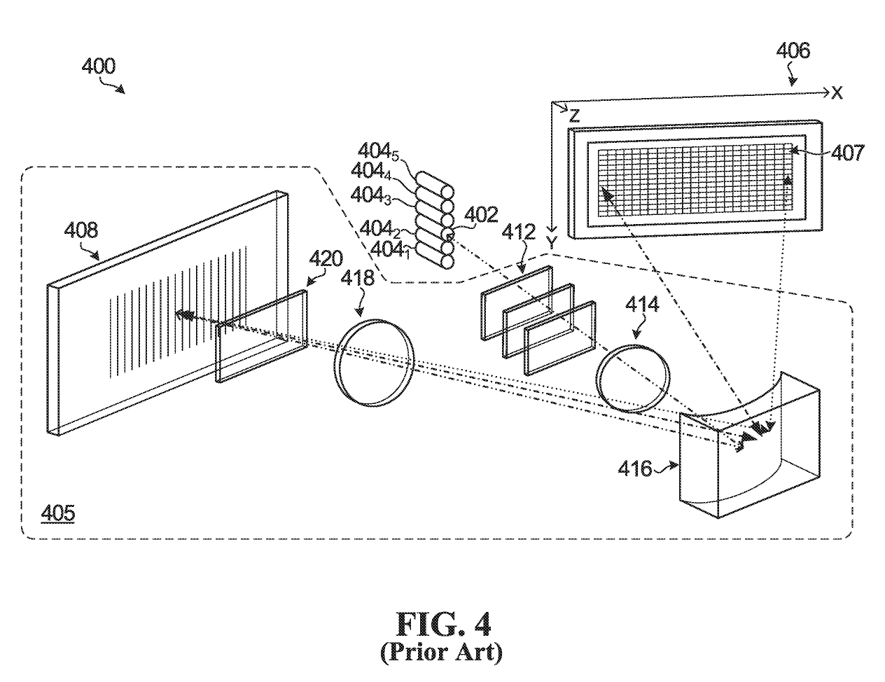

Many types of WSSs are known in the art. One common type of WSS is based on an optical deflector array. FIG. 4 is a diagram of an example of an optical deflector array based 1×5 WSS 400 that may be utilized to implement the 1×5 WSS 300 of FIG. 3. The optical deflector array based 1×5 WSS 400 includes one input port 402 and five output ports 404₁, 404₂, 404₃, 404₄, 404₅, optics 405 and an optical deflector array 406.

Optics 405 serve to spatially separate different wavelength channels of an incoming optical signal from the input port and direct the spatially separated wavelength channels onto the controllable optical deflector array 406, such that each spatially separated wavelength channel is incident on a respective region of the optical deflector array. In the illustrated example, optics 405 include polarization diversity optics 412, imaging optics 414 and 418, a cylindrical mirror 416, compensating optics 420 and a diffraction grating 408. However, a person of ordinary skill in the art will recognize that other arrangements may omit one or more of the example optical components, and/or may include additional optical components.

The optical deflector array 406 includes a plurality of deflection elements 407 arranged in a two dimensional lattice in an X-Y plane of the optical deflector array. The X-axis of the X-Y plane may be referred to as the wavelength dispersion axis because the optics 405 and the optical deflector array 406 are arranged such that the wavelength channels of the incoming optical signal are spatially separated along the X-axis of the optical deflector array.

The deflection elements of the optical deflector array 406 are controllable to steer the incident wavelength channel in a programmable direction. After each wavelength channel has been steered by the optical deflector array 406, the optics 405 re-multiplex the wavelength channels and direct them to an output port according to the steering imparted by the optical deflector array 406.

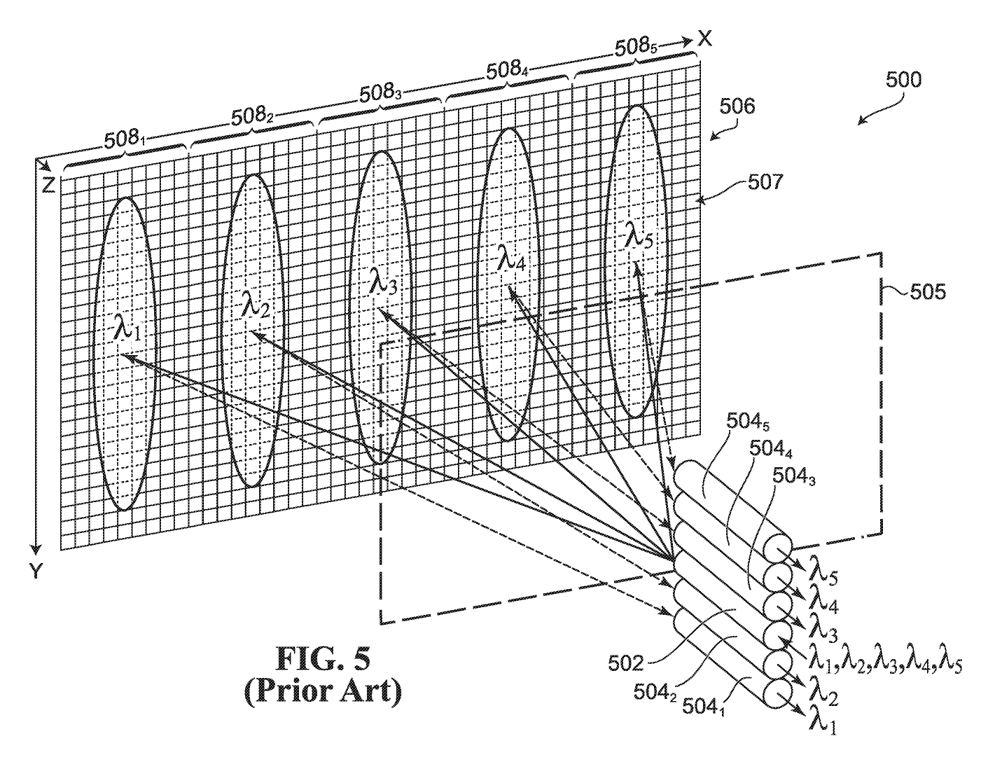

FIG. 5 is a diagram of a portion of an optical deflector array based 1×5 WSS 500 showing how an optical deflector array may be configured to implement the configuration of the 1×5 WSS 300 of FIG. 3. The optical deflector array based 1×5 WSS 500 includes an input port 502 receiving an optical signal comprising wavelengths channels λ₁, λ₂, λ₃, λ₄, λ₅, five output ports 504₁, 504₂, 504₃, 504₄, and 504₅, and an optical deflector array 506.

The wavelength channels λ₁, λ₂, λ₃, λ₄, λ₅ of the incoming optical signal from the input port 502 are spatially separated and directed onto the controllable optical deflector array 506 by optics 505 (not shown in detail), which may be similar to the optics 405 of FIG. 4. Each spatially separated wavelength channel λ₁, λ₂, λ₃, λ₄, λ₅ is incident on a respective region 508₁, 508₂, 508₃, 508₄, 508₅ of the optical deflector array 506.

The optical deflector array 506 is controlled such that deflection elements 507 in each of the respective regions 508₁, 508₂, 508₃, 508₄, 508₅ are configured to steer the incident light in a programmable direction. In particular, the optical deflector array 506 is configured such that each of the wavelength channels λ₁, λ₂, λ₃, λ₄, and λ₅ of the input signal is steered toward a respective one of the output ports 504₁, 504₂, 504₃, 504₄ and 504₅.

There are several different types of optical deflector arrays known in the art; examples include, but are not limited to, Micro-Electro-Mechanical System (MEMS) mirror arrays and liquid crystal on silicon (LCoS) pixel arrays.

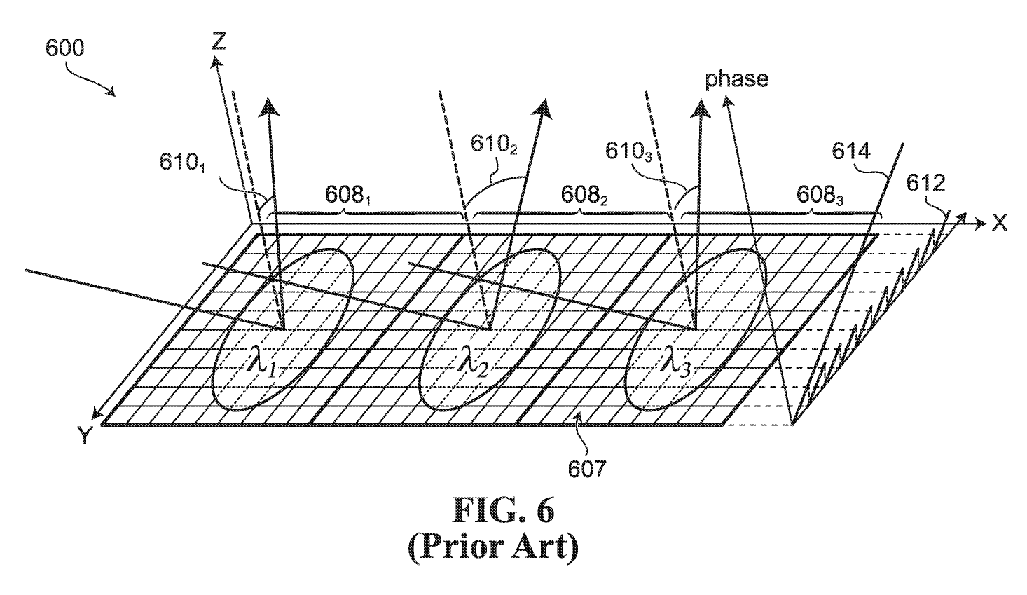

FIG. 6 is a perspective view of a portion of an LCoS pixel array device 600 showing an example of how the pixels within a region of the pixel array may be controlled to steer a wavelength channel that is incident upon the region in a programmable direction.

The LCoS pixel array device 600 includes a two dimensional lattice of pixels 607 arranged in rows and columns in an X-Y plane. Each pixel is individually drivable to provide a local phase change to an optical signal incident thereupon, thereby providing a two-dimensional array of phase manipulating regions. Manipulation of individual wavelength channels is possible once the wavelength channels of an optical signal have been spatially separated and each spatially separated wavelength channel has been directed onto a respective region of the LCoS pixel array device. Each region can be independently manipulated by driving the corresponding pixels within the region in a predetermined manner. The portion of the LCoS pixel array device 600 shown in FIG. 6 includes three regions 608₁, 608₂, 608₃, each having a respective wavelength channel λ₁, λ₂, λ₃ incident thereupon.

Each wavelength channel λ₁, λ₂, λ₃ is steered at a respective steering angle 610₁, 610₂, 610₃ from the respective region 608₁, 608₂, 608₃ upon which it is incident. In the illustrated example, the respective steering angles are measured relative to the Z-axis normal to the X-Y plane. The steering angle of each region is controlled by controlling a phase shift profile of the pixels across the respective region along the direction of the Y-axis. For example, FIG. 6 includes an example of a periodic, stepped phase shift profile 612 that may be produced across the third region 608₃ of the LCoS pixel array device 600 in the direction of the Y-axis to steer the third wavelength channel λ₃ at the intended steering angle 610₃. Due to the periodic nature of phase, the periodic, stepped phase shift profile 612 produces a cumulative phase profile 614 that provides a linear optical phase retardation in the direction of the intended deflection, thereby steering the third wavelength channel λ₃ at the intended steering angle 610₃. The cumulative phase profile 614 is produced by controlling the pixels within the third region 608₃ to provide the desired phase shift profile 612. For example, the columns of pixels in the third region 608₃ may be driven with a predetermined voltage profile corresponding to the desired phase shift profile 612 along the direction of the Y-axis.

Accordingly, by controlling the pixels in the third region 608₃ to adjust the periodic, stepped phase shift profile 612, the wavelength channel λ₃ can be selectively steered toward a desired switching output port. Wavelength channels λ₁, λ₂ can be similarly steered by controlling the phase shift profile of the pixels in the respective regions 608₁, 608₂ upon which they are respectively incident.

As noted above, controlling a conventional WSS device to selectively route wavelength channels includes configuring wavelength paths through the WSS device from an input port of the WSS to a switching output port of the WSS for those channel wavelengths that are to be routed. However, such conventional WSS devices only permit a wavelength channel to be routed to a single output port at any given time. For example, in the conventional optical deflector based 1×5 WSS device 500 of FIG. 5, the deflection elements in each of the regions 508₁, 508₂, 508₃, 508₄, 508₅ are each configured such that the respective wavelength channel that is incident thereupon is steered toward one and only one of the switching output ports 504₁, 50₂, 504₃, 504₄, 504₅.

This means that in order to monitor a wavelength channel that is routed from an switching input port to a given switching output port of a conventional WSS, the wavelength channel would have to be routed away from the switching output port to a monitoring output port (meaning that it would no longer be routed to the switching output port), or an optical tap would have to be used at the switching input port and/or at the switching output port to which the wavelength channel is routed.

In contrast, embodiments of WSS devices according to the present disclosure provide for the configuration of additional wavelength paths through a WSS device so that most of the optical power of a wavelength channel can be routed from a switching input port to a switching output port for switching purposes, while some of the optical power of the wavelength channel is simultaneously routed to a monitoring output port of the WSS for optical performance monitoring purposes. In particular, embodiments of the present disclosure provide optical deflector array based WSS devices where the optical deflector array is configured so that a first portion is used for selective switching of the wavelength channel and a second portion is used for monitoring of the wavelength channel. More particularly, the optical deflector array may be controlled so that for one or more wavelength channels a first portion of the respective region of the optical deflector array upon which the wavelength channel incident is configured to steer a first portion of the wavelength channel toward a switching output port, with a second portion of the respective region configured to steer a second portion of the wavelength channel toward a monitoring output port for monitoring purpose.

FIG. 1A is a perspective view of a portion of an optical deflector array 700 showing an example of two different phase progressions across respective portions of a region of the array according to an embodiment of the present disclosure.

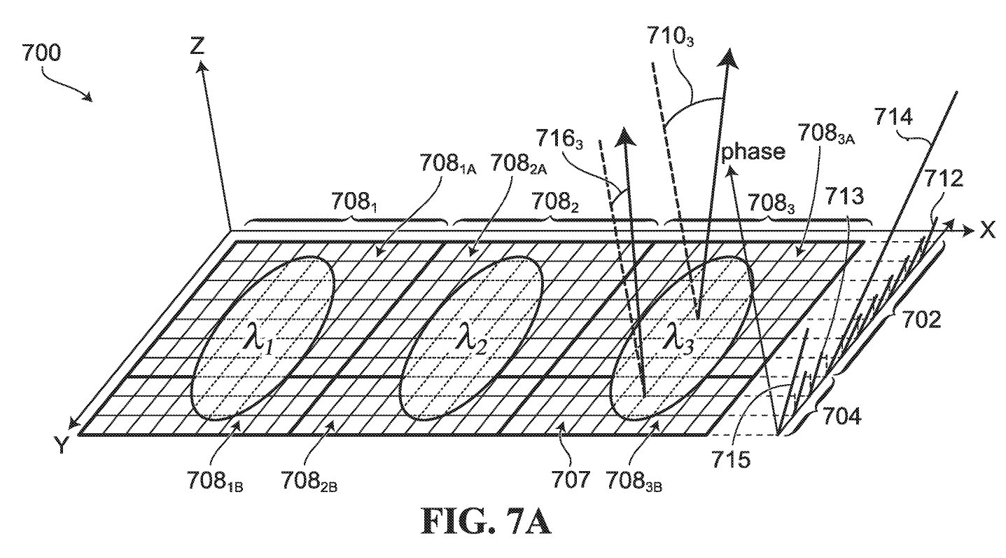

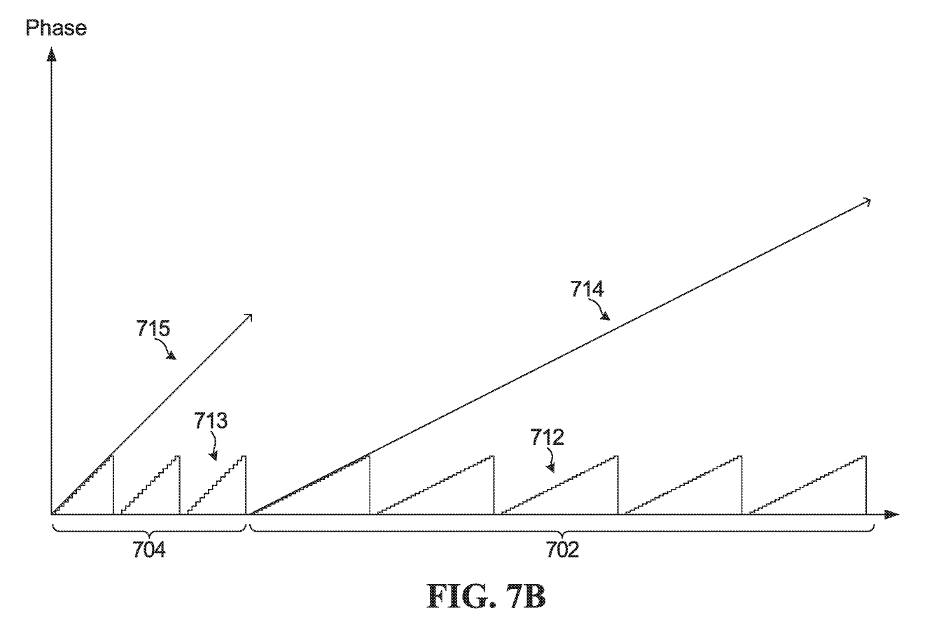

Similar to the LCoS optical deflector array 600 shown in FIG. 6, the optical deflector array 700 includes a two dimensional lattice of deflection elements 701 arranged in rows and columns in an X-Y plane and the portion of the optical deflector array 700 shown in FIG. 7A includes three regions 708₁, 708₂, 708₃, each having a respective wavelength channel λₗ, λ₂, λ₃ incident thereupon. However, unlike the LCoS optical deflector array 600 shown in FIG. 6, each of the three regions 708₁, 708₂, 708₃ has a first portion 708_{1A}, 708_{2A}, 708_{3A} and a second portion 708_{1B}, 708_{2B}, 708_{3B}. The first portion 708_{1A}, 708_{2A}, 708_{3A} of each region 708₁, 708₂, 708₃ is configurable to steer a first portion of the wavelength channel that is incident on the region so that the first portion of the wavelength channel can be selectively routed to a switching output port. The second portion 708_{1B}, 708_{2B}, 708_{3B} of each region 708₁, 708₂, 708₃ is configurable to steer a second portion of the wavelength channel that is incident on the region so that the second portion of the wavelength channel can be selectively routed to a monitoring output port. For example, the deflection elements in the first portion 708_{3A}of the third region and the deflection elements in the second portion 708_{3B} of the third region are respectively configured so that a first portion of the third wavelength channel λ₃ that is incident on the third region 708₃ is steered at a first steering angle 710₃, and a second portion of the third wavelength channel λ₃ that is incident on the third region 708₃ is steered at a second steering angle 716₃.

The respective steering angles 710₃ and 716₃ of the first and second portions 708_{3A} and 708_{3B} of the third region 708₃ are controllable by controlling phase shift profiles of the deflection elements across the respective portions of the region along the direction of the Y-axis. For example, a first phase shift profile 712 may be produced across the rows 702 of deflection elements in the first portion 708_{3A} of region 708₃ to steer the first portion of the third wavelength channel λ₃ at the intended first steering angle 710₃. A second phase shift profile 713 that may be produced across the rows 704 of deflection elements in the second portion 708_{3B} of region 708₃ to steer the second portion of the third wavelength channel λ₃ at the intended second steering angle 716₃.

The first and second phase shift profiles 712 and 713 produce first and second cumulative phase profiles 714 and 715 that provide first and second linear optical phase retardations in the direction of the intended first and second deflections, thereby steering the first and second portions of the third wavelength channel λ₃ at the intended steering angles 710₃ and 716₃, respectively.

Accordingly, by controlling the deflection elements in the first and second portions 708_{3A} and 708_{3B} third region 708₃ to adjust the first and second phase shift profiles 712 and 713, the first and second portions of the wavelength channel λ₃ can be independently steered, with the first portion being steered for wavelength selective switching purposes and the second portion being steered for monitoring purposes. First and second portions of wavelength channels λ₁, A₂ can be similarly steered by controlling the phase shift profiles of deflection elements in the respective first 708_{1A}, 708_{2A} and second 708_{1B}, 708_{2B} portions of regions 708₁ and 708₂.

In some embodiments, each of the regions 708₁, 708₂, 708₃ may be controlled independently, allowing the first portions of the respective wavelength channels λ₁, λ₂, λ₃ incident thereupon to be independently steered for switching purposes.

In other embodiments, the first portions of all the regions are configured to steer the light toward the same first output, and the second portions of all the regions are configured to steer the light toward the same second output.

For illustrative purposes, the phase shift profiles 712 and 713 appear as a series of periodic linear phase progressions across their respective portions 703_{3A} and 708_{3B} of the region 708. However, in reality the phase shift profiles 712 and 713 have a periodic, stepped profile. FIG. 7B is a plot showing the periodic, stepped profiles 712 and 713 across the respective portions 708_{3A}, and 708_{3B} of the array 700 shown in FIG. 7A.

In the example embodiment shown in FIG. 7A, each of the regions 708₁, 708₂, 708₃ is of equal size. Similarly, the respective first portions 708_{3A}, 708_{2B}, 708_{3B} are each of equal size and the respective second portions 708_{1B}, 708_{2B}, 708_{3B} are each of equal size. In other embodiments, regions may be unequally sized, or may have differently sized first and second portions.

Furthermore, in some embodiments, the relative sizes of the first and second portions of a region are adjustable. For example, the relative sizes of the first and second portions of a region upon which a wavelength channel is incident may be configured according to a desired power splitting ratio between the first portion of the wavelength channel that is steered by the first portion of the region and the second portion of the wavelength channel that is steered by the second portion of the region. This effectively allows the power splitting ratio between the amount of power in the wavelength channel that is steered for switching and the amount of power in the wavelength channel that is steered for monitoring to be adjusted.

The optical deflector array can be configured so that most (e.g., >95%) of the signal power of a wavelength channel is steered for switching purposes by the first portion of the region upon which the wavelength channel is incident, and only a small amount (e.g., <5%) of the signal power of the wavelength channel is steered for monitoring purposes by the second portion of the region upon which the wavelength channel is incident. In effect, what this means is that the first portion typically occupies a much larger percentage of the area of the region than the second portion.

The optical deflector array 700 may be an LCoS pixel array device, for example. More generally, embodiments of the present disclosure may employ any type of diffractive optical element that can be controlled to a) selectively steer a first portion of each of one or more wavelength channels incident thereupon for switching purposes and b) selectively steer a second portion of each of the one or more wavelength channels incident thereupon for monitoring purposes.

In the embodiment illustrated in FIG. 7A, the wavelength channels λ₁, λ₂, λ₃ each have an equal bandwidth an are equally spaced. However, embodiments are contemplated that support flex-grid compatibility, where channel bandwidths and/or spacings may be non-uniform and/or adaptable. For example, the relative sizes (in terms of rows and/or columns of deflection elements) and positions of the regions 708₁, 708₂, 708₃ can be adapted to accommodate different channel bandwidths and/or spacings.

In some cases not all wavelength channels need to be monitored. Accordingly, in some embodiments, for a wavelength channel that is not being monitored, the second portion of the respective region may be configured to steer the second portion of the wavelength channel toward the same switching output port as the first portion of the wavelength channel.

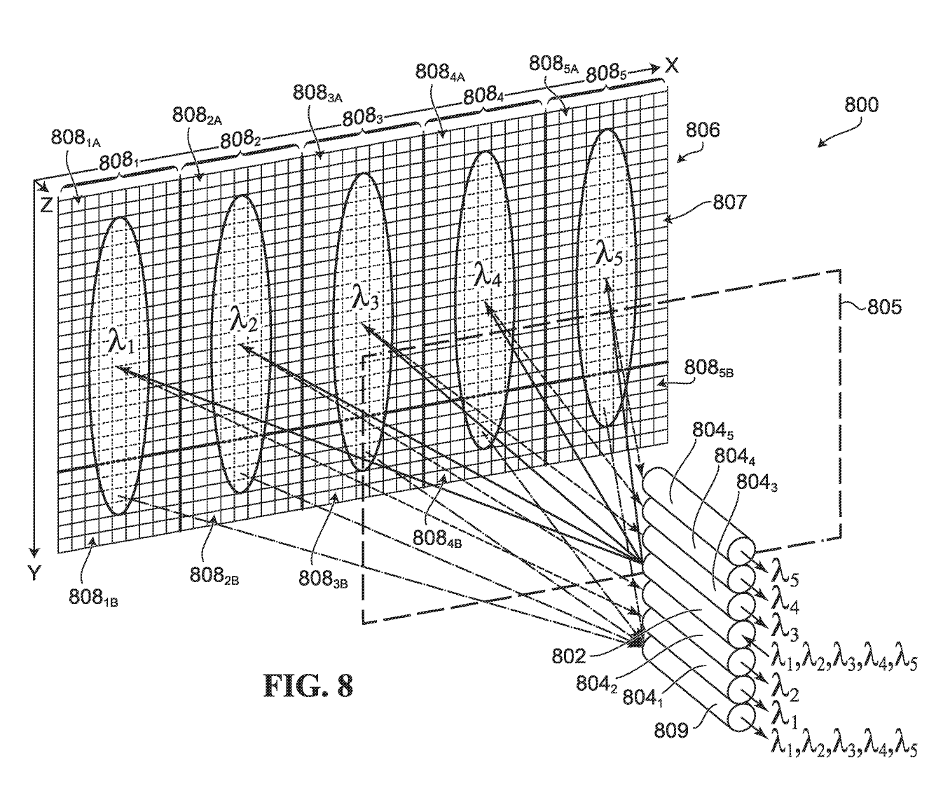

FIG. 8 is a diagram of a portion of an optical deflector array based 1×5 WSS 800 according to an embodiment of the present disclosure. The optical deflector array based 1×5 WSS 800 includes an input port 802 receiving an optical signal comprising wavelengths channels λ₁, λ₂, λ₃, λ₄, λ₅, five output ports 804₁, 804₂, 804₃, 804₄, and 804₅, a monitoring output port 809, and an optical deflector array 806. The optical deflector array 806 includes a plurality of deflection elements 807 arranged in a two dimensional lattice in an X-Y plane of the optical deflector array.

The wavelength channels λ₁, λ₂, λ₃, λ₄, λ₅ of the incoming optical signal from the input port 802 are spatially separated and directed onto the controllable optical deflector array 806 by optics 805 (not shown in detail), which may be similar to the optics 405 of FIG. 4. Each spatially separated wavelength channel λ₁, λ₂, λ₃, λ₄, λ₅ is incident on a respective region 808₁, 808₂, 808₃, 808₄, 808₅ of the optical deflector array 806. Each of the regions 808₁, 808₂, 808₃, 808₄, 808₅ has a first portion 808_{1A}, 808_{2A}, 808_{3A}, 808_{4A}, 808_{5A} and a second portion 808_{1B}, 808_{2B}, 808_{3B}, 808_{4B}, 808_{5B}. The first portion 808_{1A}, 808_{2A}, 808_{3A}, 808_{4A}, 808_{5A} of each region 808₁, 808₂, 808₃, 808₄, 808₅ is configurable to steer a first portion of the wavelength channel that is incident on the region so that the first portion of the wavelength channel can be selectively routed to one of the switching output ports 804₁, 804₂, 804₃, 804₄, 804₅. The second portion 808_{1B}, 808_{2B}, 808_{3B}, 808_{4B}, 808_{5B} of each region 808₁, 808₂, 808₃, 808₄, 808₅ is configurable to steer a second portion of the wavelength channel that is incident on the region so that the second portion of the wavelength channel can be selectively routed to the monitoring output port 809. For example, in the configuration illustrated in FIG. 8, the optical deflector array 806 is configured such that a first portion of each of the wavelength channels λ₁, λ₂, λ₃, λ₄, and λ₅ of the input signal is steered toward a respective one of the switching output ports 804₁, 804₂, 804₃, 804₄ and 804₅ and a second portion of each of the wavelength channels is steered toward the monitoring output port 809.

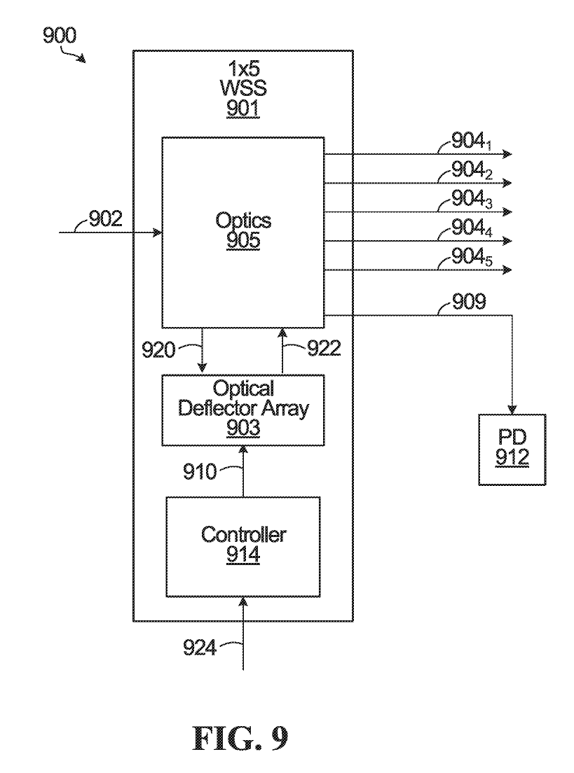

FIG. 9 is a block diagram of an apparatus 900 according to an embodiment of the present disclosure that includes a 1×5 WSS 901 with a single optical monitoring output port 909 and a photodetector (PD) 912 (e.g., a photodiode) for optical performance monitoring. The 1×5 WSS 901 has a single optical switching input port 902, five optical switching output ports 904₁, 904₂, 904₃, 904₄, 904₅, the single optical monitoring output port 909 and a control input 924. PD 912 is coupled to the optical monitoring output port 909 of 1×5 WSS 901.

The 1×5 WSS 901 includes optics 905, an optical deflector array 903 and a controller 914. Optics 905 are located between the optical switching input port 902 and the optical deflector array 903 and between the optical deflector array 903 and the optical switching output ports 904₁, 904₂, 904₃, 904₄, 904₅ and the optical monitoring output port 909. Optics 905 are configured to spatially separate wavelength channels of an optical signal received via the optical switching input port 902 and direct the spatially separated wavelength channels 920 onto the optical deflector array 903.

The optics 905 and the optical deflector array 903 may be implemented with components/technologies such as those described above. The optics 905 may include components similar to those of optics 405 shown in FIG. 4, for example. The optical deflector array 903 may be a LCoS pixel array device, for example.

The controller 914 may be implemented using any suitable electronic component/design, including analog components, digital components, or both.

The controller 914 is operatively coupled to the optical deflector array 903 at 910 and is configured to control the optical deflector array responsive to control signaling received via control input 924 so that the optical deflector array 903 steers the first and second portions of the wavelength channels as described above. The steered first and second portions of the wavelength channels are shown collectively as 922. Optics 905 multiplex the steered first portions of the wavelength channels and direct them to an optical switching output, port 904₁, 904₂, 904₃, 904₄, 904₅ according to the steering imparted to the first portions of the wavelength channels by the optical deflector array 903. Optics 905 also multiplex the steered second portions of the wavelength channels and direct them to the optical monitoring output port 909 according to the steering imparted to the second portions of the wavelength channels by the optical deflector array 903.

The PD 912 receives an optical signal that includes the second portions of the wavelength channels that are steered toward the optical monitoring output port 909 and converts the optical signal to an electrical signal. The PD 912 may be used to detect powers of single wavelength channels, or some wavelength channel combinations, for example. The electrical signal output of the PD 912 may serve as an input to subsequent signal processing components/circuits (not shown in FIG. 9) to implement further optical performance monitoring functions, such as determining optical signal to noise ratio, for example.

In some embodiments, a WSS according to the present disclosure includes two or more optical monitoring output ports. In such embodiments, for each wavelength channel to be monitored, the first portion of the region of the deflector array upon which the wavelength channel is incident is configured to steer a first portion of the wavelength channel to one of the optical switching output port(s) and the second portion of the region of the deflector array upon which the wavelength channel is incident is configured to steer a second portion of the wavelength channel to one of the multiple optical monitoring output ports.

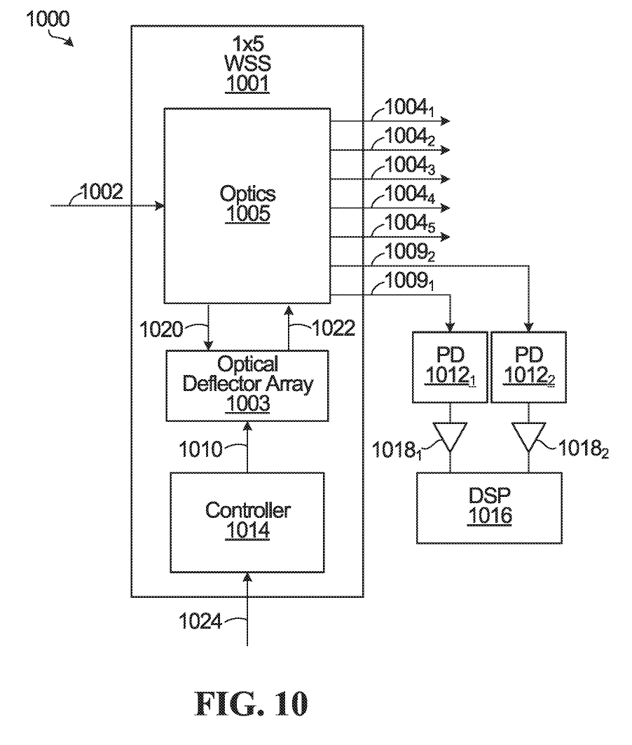

FIG. 10 is a block diagram of an apparatus 1000 according to an embodiment of the present disclosure that includes a 1×5 WSS 1001 with two optical monitoring output ports 1009₁, 1009₂, two photodetectors (PDs) 1012₁, 1012₂ (e.g., two photodiodes), two amplifiers 1018₁, 1018₂ (e.g., amp circuits), and a digital signal processor (DSP) 1016 for optical performance monitoring. The 1×5 WSS 1001 has a single optical switching input port 1002, five optical switching output ports 1004₁, 1004₂, 1004₃, 1004₄, 1004₅, the two optical monitoring output ports 1009₁, 1009₂ and a control input 1024. The two PDs 1012₁ and 1012₂ are respectively coupled to the two optical monitoring output ports 1009₁ and 1009₂ of 1×5 WSS 1001.

The 1×5 WSS 1001 includes optics 1005, an optical deflector array 1003 and a controller 1014. The optics 1005, the optical deflector array 1003 and the controller 1014 are arranged and configured to function in the same manner as the corresponding components of the embodiment shown in FIG. 9, except that the controller 1014, which is operatively coupled to the optical deflector array 1003 at 1010 is configured to control the optical deflector array 1003 responsive to control signaling received via control input 1024 so that the optical deflector array 903 steers the second portion of each of the wavelength channels that are to be monitored so that they are selectively routed to either the first optical monitoring output port 1009₁ or the second optical monitoring output port 1009₂.

For completeness, it is noted that the spatially separated wavelength channels directed onto the optical deflector array 1003 by optics 1005 are indicated at 1020 and the steered first and second portions of the wavelength channels are indicated collectively at 1022.

In some embodiments, the controller 1014 may be configured to control the optical deflector array 1003 so that a first wavelength channel (or subset of wavelength channels) can be monitored at the optical monitoring output port 1009₁ and a second wavelength channel (or subset of wavelength channels) can be monitored at the other optical monitoring output port 1009₂. For example, the controller 1014 may be configured to control the optical deflector array 1003 so that the second portion of the region of the optical deflector array 1003 upon which the first wavelength channel is incident is configured to steer the second portion of the first wavelength channel toward the first monitoring output port 1009₁. Similarly, the controller 1014 may be configured to control the optical deflector array 1003 so that the second portion of the region of the optical deflector array 1003 upon which the second wavelength channel is incident is configured to steer the second portion of the second wavelength channel toward the second monitoring output port 10092.

The first and second photodetectors 1012₁ and 1012₂ receive optical signals that include the second portions of the wavelength channels that are steered toward the first and second monitoring output ports 1009₁ and 1009₂, respectively, and convert the optical signals to electrical signals. The amplifiers 1018₁ and 1018₂ amplify the corresponding electrical signals.

The DSP 1016 processes the amplified electrical signals to implement a desired optical performance monitoring function.

In optical systems such as dense wavelength division multiplexing (DWDM) systems, low frequency modulations can be applied to wavelength channels to carry channel wavelength information and other identification information, which improves fiber link management and enables power monitoring. Low frequency modulation based channel monitoring, e.g., pilot-tone based channel monitoring, can be used for various applications (e.g., for DWDM systems). However, its applications are limited by the stimulated Raman scattering (SRS) caused crosstalk of modulated optical signals in the optical communication links. This crosstalk can substantially distort the low frequency modulations in optical signals and hence reduce channel monitoring accuracy and performance.

In some embodiments, the DSP 1016 may be configured to perform SRS crosstalk suppression based on outputs from he first and second monitoring output ports 1009₁ and 1009₂. For example, in some embodiments the controller 1014 is configured to control the optical deflector array 1003 so that first and second subsets of the wavelength channels that include about the same number of non-overlapping wavelength channels can be monitored via the first and second monitoring output ports 1009₁ and 1009₂ as described above, and the DSP 1016 is configured to suppress stimulated SRS crosstalk between wavelength channels in the received optical signal by subtracting the corresponding electric signal strengths, which are proportional to the wavelength channel powers, between corresponding pairs of wavelength channels in the first and second subsets.

In some embodiments, the first and second subsets of wavelength channels include odd wavelength channels and even wavelength channels, respectively. In other embodiments, wavelength channels can be arbitrarily assigned to the first and second subsets (e.g., not limited to an even/odd split).

In some embodiments, the DSP 1016 may include analog-to-digital converters (ADCs) to digitize the two electrical signals and the subtraction could then be performed digitally or via software.

In another embodiment, the signal subtraction in the frequency domain can be implemented using circuit components. For example, the signal subtraction could be implemented with a subtraction circuit (e.g., an op-amp circuit) instead of digital signal processing.

It is noted that the wavelength selective switches 901 and 1001 shown in FIGS. 9 and 10 both have one input switching port and multiple output switching ports. However, it should be understood that embodiments of the present disclosure are not limited to such configurations. For example, embodiments of the present disclosure also include WSS configurations with multiple input ports and one output port.

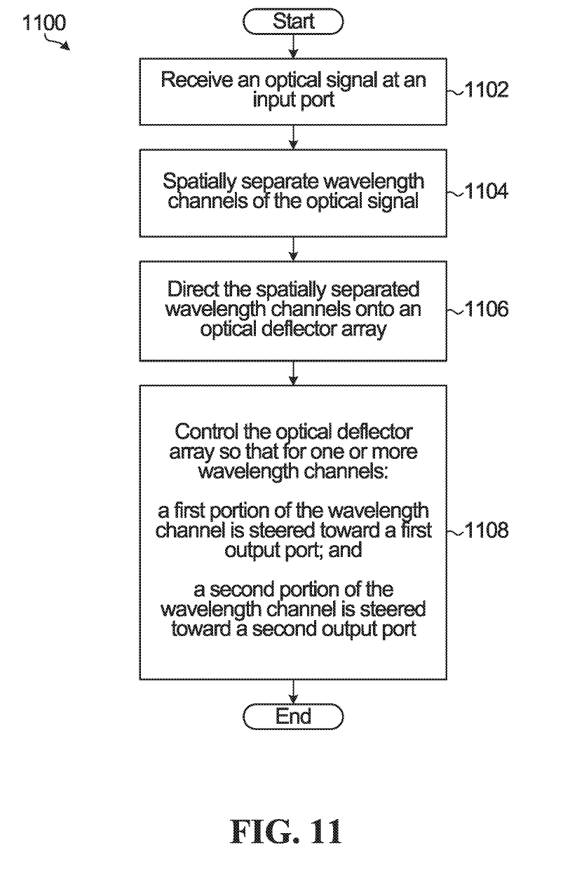

FIG. 11 is a flow diagram of example operations 1100 in an apparatus according to example embodiments described herein. Operations 1100 may be indicative of operations occurring in a WSS that is part of an access ROADM node in a DWDM optical network, for example.

Operations 1100 begin with the apparatus receiving an optical signal at an input port (block 1102).

Wavelength channels of the optical signal are spatially separated (block 1104). The spatial separation of the wavelength channels may be accomplished using a diffractive grating or any other type of dispersive optical element that is capable of spatially separating the wavelength channels of the optical signal.

The spatially separated wavelength channels are directed onto an optical deflector array (block 1106). The direction of the spatially separated wavelength channels may involve reflection by one or more mirrors and/or focusing by one or more lenses, for example.

The optical deflector array is controlled so that, for one or more of the wavelength channels: i) a first portion of the respective region of the optical deflector array upon which the wavelength channel is incident is configured to steer a first portion of the wavelength channel toward a first output port; and ii) a second portion of the respective region of the optical deflector array upon which the wavelength channel is incident is configured to steer a second portion of the wavelength channel toward a second output port (block 1108). In some embodiments, the first output port is a switching output port and the second output port is a monitoring output port.

The example operations 1100 are illustrative of an example embodiment. Various ways to perform the illustrated operations, as well as examples of other operations that may be performed, are described herein. Further variations may be or become apparent.

For example, operations 1100 may further include, for each of the respective regions, configuring a size of the second portion of the respective region relative to a size of the first portion of the respective region according to a desired power splitting ratio.

In some embodiments, the optical deflector array includes multiple pixels arranged in a two dimensional lattice, and controlling the optical deflector array at block 1108 includes controlling phase shift profiles of pixels in the respective regions of the optical deflector array upon which the wavelength channels are incident. For example, controlling phase shift profiles of pixels in the respective regions of the optical deflector array may involve controlling the optical deflector array so that for each wavelength channel to be monitored: pixels in the first portion of the respective region of the optical deflector array upon which the wavelength channel is incident have a respective first phase shift profile; and pixels in the second portion of the respective region of the optical deflector array upon which the wavelength channel is incident have a respective second phase shift profile.

In some embodiments, the two dimensional lattice of pixels of the optical deflector array extends in a first direction along a wavelength dispersion axis and in a second direction along a second axis perpendicular to the wavelength dispersion axis. In such embodiments, the operations at blocks 1104 and 1106 may be such that the wavelength channels of the optical signal are spatially dispersed along the wavelength dispersion axis, and the operations at block 1108 may involve controlling the optical deflector array so that for each wavelength channel to be monitored: pixels in the first portion of the respective region of the optical deflector array upon which the wavelength channel is incident have a respective first phase shift profile along the direction of the second axis; and pixels in the second portion of the respective region of the optical deflector array upon which the wavelength channel is incident have a respective second phase shift profile along the deflection of the second axis.

In some embodiments, the apparatus may include at least two monitoring output ports, including a first monitoring output port and a second monitoring output port. In such embodiments, the operations at block 1108 may involve controlling the optical deflector array so that: for each wavelength channel of a first subset of the wavelength channels, the second portion of the respective region of the optical deflector array upon which the wavelength channel is incident is configured to steer the second portion of the wavelength channel toward the first monitoring output port; and for each wavelength channel of a second subset of the wavelength channels to be monitored, the second portion of the respective region of the optical deflector array upon which the wavelength channel is incident is configured to steer the second portion of the wavelength channel toward the second monitoring output port. The first and second subsets of the wavelength channels may include about the same number of non-overlapping wavelength channels.

In some cases, operations 1100 may further include performing stimulated Raman scattering (SRS) crosstalk suppression based on the outputs from the first and second monitoring output ports. For example, performing SRS crosstalk suppression may involve, for each wavelength channel of the first subset, subtracting from the second portion of the wavelength channel that is steered toward the first monitoring output port the second portion of a corresponding wavelength channel in the second subset that is steered toward the second monitoring output port.

Numerous modifications and variations of the present application are possible in light of the above teachings. It is therefore to be understood that within the scope of the appended claims, the application may be practiced otherwise than as specifically described herein.

In addition, although described primarily in the context of methods, apparatus and equipment, other implementations are also contemplated, such as in the form of instructions stored on a non-transitory computer-readable medium, for example.

1. A method for wavelength selective switching, the method comprising:
receiving at least one spatially separated wavelength channel of an optical signal on an optical deflector array, each wavelength channel being incident on a respective region of the optical deflector array;
controlling the optical deflector array so that, for one or more of the at least one wavelength channel:
a first portion of the region of the optical deflector array is configured to steer a first portion of the wavelength channel toward a first output port; and
a second portion of the region of the optical deflector array is configured to steer a second portion of the wavelength channel toward a second output port.

2. The method of claim 1, wherein the first output port is a switching output port and the second output port is a monitoring output port.

3. The method of claim 1, further comprising:
receiving the optical signal at an input port;
spatially separating the at east one wavelength channel of the optical signal; and
directing the at least one spatially separated wavelength channel onto the optical deflector array so that each wavelength channel is incident on its respective region of the optical deflector array.

4. The method of claim 1, further comprising for each respective region, configuring a size of the second portion of the region relative to a size of the first portion of the region according to a desired power splitting ratio.

5. The method of claim 1, wherein:
the optical deflector array comprises a plurality of pixels arranged in a two dimensional lattice; and
controlling the optical deflector array comprises controlling phase shift profiles of pixels in the respective regions of the optical deflector array.

6. The method of claim 5, wherein controlling phase shift profiles of pixels in the respective regions of the optical deflector array comprises controlling the optical deflector array so that for each wavelength channel to be monitored:
pixels in the first portion of the region of the optical deflector array have a first phase shift profile; and
pixels in the second portion of the region of the optical deflector array have a second phase shift profile.

7. The method of claim 6, wherein:
the two dimensional lattice of pixels extends in a first direction along a wavelength dispersion axis and in a second direction along a second axis perpendicular to the wavelength dispersion axis; and
the phase shift profiles are along the direction of the second axis.

8. The method of claim 5, wherein the optical deflector array is a liquid crystal on silicon (LCoS) pixel array.

9. The method of claim 2, wherein:
the one or more wavelength channels include a first wavelength channel and a second wavelength channel; and
controlling the optical deflector array comprises controlling the optical deflector array so that:
for the first wavelength channel, the second portion of the region of the optical deflector array upon which the first wavelength channel is incident is configured to steer the second portion of the first wavelength channel toward the first monitoring output port; and
for the second wavelength channel, the second portion of the region of the optical deflector array upon which the second wavelength channel is incident is configured to steer the second portion of the second wavelength channel toward a second monitoring output port.

10. The method of claim 2, wherein:
the one or more wavelength channels include first and second subsets of wavelength channels; and
controlling the optical deflector array comprises controlling the optical deflector array so that:
for each wavelength channel of the first subset, the second portion of the region of the optical deflector array upon which the wavelength channel is incident is configured to steer the second portion of the wavelength channel toward the first monitoring output port; and
for each wavelength channel of the second subset, the second portion of the region of the optical deflector array upon which the wavelength channel is incident is configured to steer the second portion of the wavelength channel toward a second monitoring output port.

11. The method of claim 10, further comprising performing stimulated Raman scattering (SRS) crosstalk suppression based on outputs from the first and second monitoring output ports.

12. The method of claim 11, wherein performing stimulated Raman scattering (SRS) crosstalk suppression comprises, for each wavelength channel of the first subset, subtracting from the second portion of the wavelength channel that is steered toward the first monitoring output port the second portion of a corresponding wavelength channel in the second subset that is steered toward the second monitoring output port.

13. An apparatus comprising:
one or more first output ports;
one or more second output ports;
an optical deflector array configured to receive incident thereupon at least one spatially separated wavelength channel of an optical signal, each wavelength channel being incident on a respective region of the optical deflector array; and
a controller operatively coupled to the optical deflector array and configured to control the optical deflector array so that for one or more of the at least one wavelength channel:
a first portion of the region of the optical deflector array is configured to steer a first portion of the wavelength channel toward one of the one or more first output ports; and
a second portion of the region of the optical deflector array is configured to steer a second portion of the wavelength channel toward one of the one or more second output ports.

14. The apparatus of claim 13, wherein the one or more first output ports include one or more switching output ports and the one or more second output ports include one or more monitoring output ports.

15. The apparatus of claim 13, further comprising:
an input port to receive the optical signal; and
optics located between the input port and the optical deflector array and configured to:
spatially separate the at least one wavelength channel of the optical signal; and
direct the at least one spatially separated wavelength channel onto the optical deflector array so that each wavelength channel is incident on its respective region of the optical deflector array.

16. The apparatus of claim 13, wherein for each region of the optical deflector array, the controller is further configured to configure a size of the second portion of the region relative to a size of the first portion of the region according to a desired power splitting ratio.

17. The apparatus of claim 13, wherein the optical deflector array comprises a plurality of pixels arranged in a two dimensional lattice and the controller is configured to control the optical deflector array by controlling phase shift profiles of pixels in the respective regions of the optical deflector array.

18. The apparatus of claim 17, wherein the controller is configured to control phase shift profiles of pixels in the respective regions of the optical deflector array so that for each wavelength channel to be monitored:
pixels in the first portion of the region of the optical deflector array have a first phase shift profile; and
pixels in the second portion of the region of the optical deflector array have a second phase shift profile.

19. The apparatus of claim 18, wherein:
the two dimensional lattice of pixels extends in a first direction along a wavelength dispersion axis and in a second direction along a second axis perpendicular to the wavelength dispersion axis; and
the phase shift profiles are along the direction of the second axis.

20. The apparatus of claim 17, wherein the optical deflector array is a liquid crystal on silicon (LCoS) pixel array.

21. The apparatus of claim 14, wherein:
the one or more wavelength channels include a first wavelength channel and a second wavelength channel; and
controlling the optical deflector array comprises controlling the optical deflector array so that:
for the first wavelength channel, the second portion of the region of the optical deflector array upon which the first wavelength channel is incident is configured to steer the second portion of the first wavelength channel toward a first monitoring output port of the one or more monitoring output ports; and
for the second wavelength channel, the second portion of the region of the optical deflector array upon which the second wavelength channel is incident is configured to steer the second portion of the second wavelength channel toward a second monitoring output port of the one or more monitoring output ports.

22. The apparatus of claim 14, wherein:
the one or more wavelength channels include first and second subsets of wavelength channels; and
the controller is configured to control the optical deflector array so that:
for each wavelength channel of the first subset, the second portion of the region of the optical deflector array upon which the wavelength channel is incident is configured to steer the second portion of the wavelength channel toward a first monitoring output port of the one or more monitoring output ports; and
for each wavelength channel of the second subset, the second portion of the region of the optical deflector array upon which the wavelength channel is incident is configured to steer the second portion of the wavelength channel toward a second monitoring output port of the one or more monitoring output ports.

23. The apparatus of claim 22, further comprising a processor configured to perform stimulated Raman scattering (SRS) crosstalk suppression based on outputs from the first and second monitoring output ports.

24. The apparatus of claim 23, wherein the processor is configured to perform stimulated Raman scattering (SRS) crosstalk suppression by:
for each wavelength channel of the first subset, subtracting from the second portion of the wavelength channel that is steered toward the first monitoring output port the second portion of a corresponding wavelength channel in the second subset that is steered toward the second monitoring output port.

25. A wavelength selective switch (WSS) comprising the apparatus of claim 13.
